(19) United States
(12) Patent Application Publication
(10) Pub. No.: US 2014/0019892 A1
(43) Pub. Date: Jan. 16, 2014

(54) Systems and Methods for Generating Application User Interface with Practically Boundless Canvas and Zoom Capabilities

(71) Applicant: John Mayerhofer, Palo Alto, CA (US)

(72) Inventor: John Mayerhofer, Palo Alto, CA (US)

(73) Assignee: SAP AG, Walldorf (DE)

(21) Appl. No.: 13/549,723

(22) Filed: Jul. 16, 2012

(51) Int. Cl. G06F 3/048

(52) U.S. Cl. 715/763; 715/762

(57) ABSTRACT

In one embodiment, a computer-implemented method comprises receiving a user request in a controller. The controller stores information about the display of data on a canvas. The canvas is generated for display on a user interface. The canvas includes a plurality of application elements and a pod. The canvas is displayable in levels of context. First display information is generated based on the canvas and a first type of user request. The first display information includes one of the levels of context of the canvas and the pod. Second display information of the pod is generated based on the pod and a second type of user request. The second display information includes application elements of a selected level of context of the canvas. A selected application element of the second display information is modified based on a third type of user request.

### BACKGROUND

The present invention relates to computing, and in particular, to systems and methods for generating application user interface with practically boundless canvas and zoom capabilities.

Some software applications, such as Prezi, provide tools to display presentation data, which is almost all static. The only dynamic application element on the display is video. However, the video is not data driven. The link to the video is static, and the data comes from one application element that is a static source file. The data is not dynamically driven when the video is played. Further, the end user cannot embed application elements in the display other than a static file, such as a YouTube video.

Some applications provide zooming in and out of visual displays. One such application is Google Earth that provides a visual display of geographically keyed data, such as a location on Earth, using satellite images and other imagery. However, the end user is restricted to using only the geographically keyed data. Also, the end user cannot rearrange the visual elements.

One problem associated with the use of software applications is the static and generally constrained arrangement of the displayed data and how the visual elements are framed, as well as the constrained size of the visual elements and the frames. This means that end user cannot select or freely rearrange, or resize, visual elements that are data driven. Consequently, there exists a need for improved systems and methods for displaying data based on the desired context of an end user. The present invention addresses this problem, and others, by providing systems and methods for generating a user interface with practically boundless canvas and zoom capabilities and which the user has control over.

### SUMMARY

Embodiments of the present invention include systems and methods for generating application user interface with practically boundless canvas and zoom capabilities. In one embodiment, the present invention includes a computer-implemented method comprising receiving a user request in a controller, wherein the controller stores information about the display of data on a canvas, wherein a data store stores the data and the canvas. The method further including generating, by the controller, the canvas for display on a user interface, the canvas including a plurality of application elements and a pod, the canvas being displayable in levels of context, generating first display information based on the canvas and a first type of user request, the first display information including one of the levels of context of the canvas and the pod, generating second display information of the pod based on the pod and a second type of user request, the second display information including application elements of a selected level of context of the canvas, and modifying a selected application element of the second display information based on a third type of user request.

In one embodiment, modifying the selected application element further includes inserting a dynamic application element in the selected level of context of the canvas.

In one embodiment, modifying the selected application element further includes inserting a selected one of a static application element and a dynamic application element in the selected level of context of the canvas in the second display information.

In one embodiment, the method further comprises generating third display information based on the canvas and a third type of user request, after modifying the selected application element of the second display information.

In one embodiment, the second type of user request includes a plurality of palettes, each palette including a plurality of icons, each icon corresponding to a function to be performed by the controller for navigating or modifying the canvas, application elements and levels of context.

In one embodiment, the method further comprises regenerating the first display information based a fourth type of user request, after generating the second display information.

In one embodiment, the second display information includes a canvas icon, the fourth type of user request is an instruction to navigate back to the canvas received in response to a selection of the canvas icon.

In one embodiment, the first type of user request is an instruction to navigate between levels of context of the canvas.

In one embodiment, the first display information includes the pod in every level of context of the canvas.

In one embodiment, the first display information includes the pod in every application element in the selected level of context of the canvas.

In one embodiment, the pod in the first display information has identical forms in every level of context of the canvas.

In one embodiment, the method further comprises searching the canvas based on a fifth type of user request, determining a location in the canvas based on the search of the canvas, and generating fourth display information based on the determined location in the canvas in response to a user request to navigate to the determined location.

In one embodiment, the method further comprises interconnecting application elements in the canvas based on a sixth type of user request.

In one embodiment, modifying the selected application element further comprises inserting, deleting or modifying a selected one of a static application element and a dynamic application element in the selected level of context of the canvas in the second display information.

In another embodiment, the present invention includes a computer readable medium embodying a computer program for performing a method and embodiments described above.

In another embodiment, the present invention includes a computer system comprising one or more processors implementing the techniques described herein. For example, the system includes a controller receives a user request. The controller stores information about the display of data on a canvas. A data store stores the data and the canvas. The controller generates the canvas for display on a user interface. The canvas includes a plurality of application elements and a pod. The canvas is displayable in levels of context. The controller generates first display information based on the canvas and a first type of user request. The first display information includes one of the levels of context of the canvas and the pod. The controller generates second display information of the pod based on the pod and a second type of user request. The second display information includes application elements of a selected level of context of the canvas. The controller modifies a selected application element of the second display information based on a third type of user request.

The following detailed description and accompanying drawings provide a better understanding of the nature and advantages of the present invention.

### BRIEF DESCRIPTION OF THE DRAWINGS

FIG. 1 is a schematic representation of a system for generating an application user interface with practically boundless canvas and zoom capabilities according to an embodiment of the present invention.

FIG. 2 is a schematic representation of a user interface of a canvas formed using the system of FIG. 1.

FIG. 3 is a schematic representation of a user interface of a pod formed using the system of FIG. 1.

FIG. 4 illustrates a process for generating a user interface with practically boundless canvas and zoom capabilities according to an embodiment of the present invention.

FIG. 5 illustrates a process for navigating and modifying a canvas of FIG. 2.

FIG. 6 illustrates an example screenshot for an initial canvas of FIG. 2.

FIG. 7 illustrates an example screenshot for a modified canvas of FIG. 5.

FIG. 8 illustrates an example screenshot of the canvas of FIG. 7 at a first level of context.

FIG. 9 illustrates an example screenshot of the canvas of FIG. 7 at a second level of context.

FIG. 10 illustrates an example screenshot of the canvas of FIG. 7 at a third level of context.

FIG. 11 illustrates an example screenshot of the canvas of FIG. 7 at a fourth level of context.

FIG. 12 illustrates an example screenshot of the canvas of FIG. 7 at a fifth level of context.

FIG. 13 illustrates an example screenshot of the canvas of FIG. 7 at a sixth level of context.

FIG. 14 illustrates an example screenshot of the canvas of FIG. 7 at a seventh level of context.

FIG. 15 illustrates an example screenshot of the canvas of FIG. 7 at an eighth level of context.

FIG. 16 illustrates an example screenshot of the canvas of FIG. 7 at a ninth level of context.

FIG. 17 illustrates an example screenshot of the canvas of FIG. 7 at an alternative eighth level of context.

FIG. 18 illustrates hardware used to implement embodiments of the present invention.

### DETAILED DESCRIPTION

Described herein are techniques for generating an application user interface with practically boundless canvas and zoom and pan capabilities. The apparatuses, methods, and techniques described below may be implemented as a computer program (software) executing on one or more computers. The computer program may further be stored on a computer readable medium. The computer readable medium may include instructions for performing the processes described below. In the following description, for purposes of explanation, numerous examples and specific details are set forth in order to provide a thorough understanding of the present invention. It will be evident, however, to one skilled in the art that the present invention as defined by the claims may include some or all of the features in these examples alone or in combination with other features described below, and may further include modifications and equivalents of the features and concepts described herein.

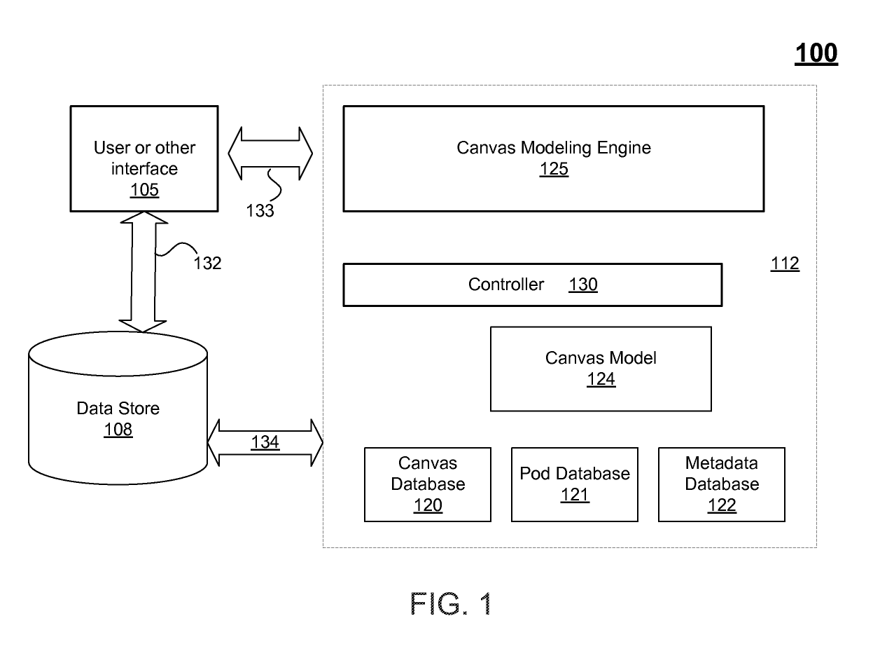

FIG. 1 is a schematic representation of a system 100 for generating an application user interface with practically boundless canvas and zoom capabilities according to an embodiment of the present invention. The term “practically boundless” is used herein to refer to the size of a canvas being limited by the practicality of system 100, such as the size of memory resources. System 100 includes a user or other interface 105, a data store 108, and a canvas model system 112. In the following description, the term “data store” is used interchangeably with “database.” Data store 108 may comprise one or more data stores. Canvas model system 112 comprises a canvas database 120, a pod database 121, a metadata database 122, a canvas model 124, a canvas modeling engine 125 and a controller 130.

Information is conveyed between user interface 105, data store 108, and canvas model system 112, along data flow paths 132, 133, and 134. For example, canvas model system 112 accesses the contents of database 108 over data flow path 134 when generating a user interface with practically boundless canvas and zoom capabilities.

Canvas database 120 and pod database 121 are sets of data that are stored in database 108 and accessed by canvas model system 112. Canvas database 120 stores data for generating a canvas that may be displayed on user interface 105. The canvas may provide a visual representation of one or more levels of context. The canvas may include application elements that allow a user to enter data, manipulate data or perform functions or operations on the data. Pod database 121 stores data for generating a pod icon for display on the canvas and a pod that allows a user to modify or navigate within the canvas or change, modify, and rearrange application elements in the canvas. Metadata database 122 stores metadata that is used for generating, navigating and processing in and within the canvas and pod. Canvas modeling engine 125 executes a process or algorithm that analyzes data from canvas database 120, pod database 121 and metadata database 122 and generates canvas model 124 based on the analysis.

User or other interface 105 is a collection of one or more data input/output devices for interacting with a human user or with another data processing system to receive and output data. For example, interface 105 can be a presentation system, one or more software applications, or a data communications gateway, for example. Data flow path 132 is data communicated over interface 105 that retrieves data from or causes a change to data stored in database 108. Such changes include the insertion, deletion, or modification of all or a portion of the contents of database 108. Data output over interface 105 can present the results of data processing activities in system 100. For example, data flow path 133 can convey the results of queries or other operations performed on canvas model system 112 for presentation on a monitor or a data communications gateway. For example, user interface 105 may receive single or multi-touch gestures or mouse commands for navigating (such as zooming or panning), selecting, altering, or modifying data or displays.

Data store 108 is a collection of information that is stored at one or more data machine readable storage devices (e.g., data stores). Data store 108 may be a single data store or multiple data stores, which may be coupled to one or more software applications for storing application data. Data store 108 may store data as a plurality of data records. Each data record comprises a plurality of data elements (e.g., fields of a record). Data store 108 may include different structures and their relations (e.g., data store tables, data records, fields, and foreign key relations). Additionally, different structures and fields may include data types, descriptions, or other metadata, for example, which may be different for different data records. Data store 108 may store data used for canvas database 120, pod database 121, metadata database 122, and canvas model 124. Data flow path 134 conveys information describing changes to data stored in data store 108 between canvas model system 112 and data store 108. Such changes include the insertion, deletion, and modification of all or a portion of the contents of one or more data stores.

Canvas model system 112 is a collection of data processing activities (e.g., one or more data analysis programs or methods) performed in accordance with the logic of a set of machine-readable instructions. The data processing activities can include running instructions, such as user requests, on the contents of data store 108. The results of such user requests can be aggregated to yield an aggregated result set. The instructions can be, for example, to navigate, modify or create a canvas, a pod or elements thereof. The result of the instruction can be conveyed to interface 105 over data flow path 133. Interface 105 can, in turn, render the result over an output device for a human or other user or to other systems. This output of result drawn from canvas model system 112, based on data from data store 108, allows system 100 to accurately portray the canvas.

Instructions from the canvas modeling engine 125 or the user interface 105 may be received by controller 130. Controller 130 may be a component on the same system as a data store or part of a different system and may be implemented in hardware, software, or as a combination of hardware and software, for example. Controller 130 receives an instruction from canvas modeling engine 125 and generates one or more requests based on the received instruction depending on the data stores 108 and data sets that are to be accessed. Data store 108 transforms the request from controller 130 into an appropriate syntax compatible with the data store.

Controller 130 receives data from data store 108. In responding to the query from canvas modeling engine 125, controller 130 may aggregate the data of the data sets from data store 108. The aggregation may be implemented with a join operation, for example. Finally, controller 130 returns the aggregated data to canvas modeling engine 125 in response to the query.

In some embodiments, system 100 is used in any application that includes a significant number of application elements related to each other, or within the context of the user's specific objective, the users enterprise or business network, or the user in general.

System 100 may be used in applications having relationships between the elements along a certain dimension that are in a hierarchical or network pattern. Although system 100 is described for a parent's plan for a child, the system may be used in other application domains, such as supply chain visibility, resource planning, human capital management, goal management, customer relationship management, or process control systems.

In some embodiments, canvas modeling engine 125 provides an application user interface framework (such as a work space) that enables the user to see on user interface 105 the world like most people naturally do, namely in context without spatial boundaries.

In some embodiments, system 100 may provide continuous context between application elements in an application user interface (or application space) that may be transactional or otherwise, and displayed on user interface 105. System 100 may enable a flexible application specific, and even user defined, visual motif that ties various application elements together. System 100 may provide continuous context between application elements in an application user interface on user interface 105. System 100 may provide rapid navigation to various elements within potentially complex applications. System 100 may enable essentially unlimited syndication of data and application elements into the application user interface. System 100 may provide a high degree of control to the end user over the application user interface on user interface 105.

In some embodiments, system 100 may enable identification of patterns in any one level of context or among multiple levels of context within an application space. System 100 may enable definition/description of any one level of context.

System 100 may create a user interface paradigm that lends itself to common end points (such as web and multi-touch devices).

System 100 may enable multiple people to work (interact with application elements and data) in the application space at any given time.

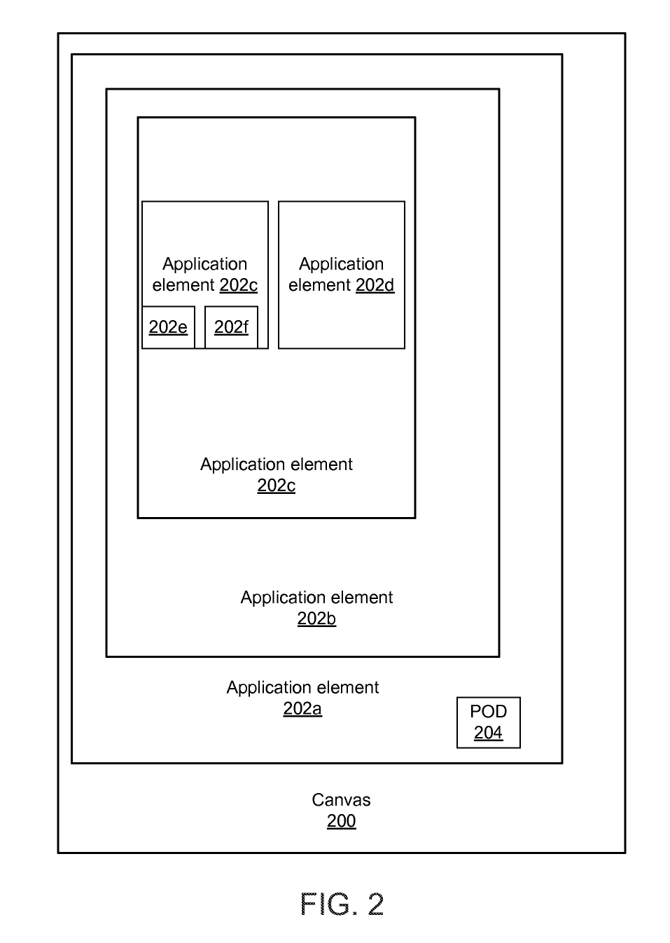

FIG. 2 is a schematic representation of a user interface of a canvas 200 formed using canvas model 124. The user interface comprises canvas 200 that displays a plurality of application elements 202, and a pod icon 204. Although any number of application elements 202 may be used, for simplicity and clarity, FIG. 2 shows seven application elements 202 (e.g., application element 202a-application element 202f). Canvas modeling engine 125 generates canvas 200 based on a fixed or user created template with predetermined or user defined application elements and application elements 202.

Application element 202 may be arranged in one or more levels on canvas 200. For example, application element 202a is shown at a first level on canvas 200. Application element 202b is shown at a second level on application element 202a. Application element 202c is shown at a third level on application element 202b. Application element 202c and application element 202d are shown at a fourth level on application element 202c. Application element 202e and application element 202f are shown on a fifth level on application element 202c. Pod icon 204 is shown on application element 202a. In some embodiments, pod icon 204 may be displayed on any or all of application element 202.

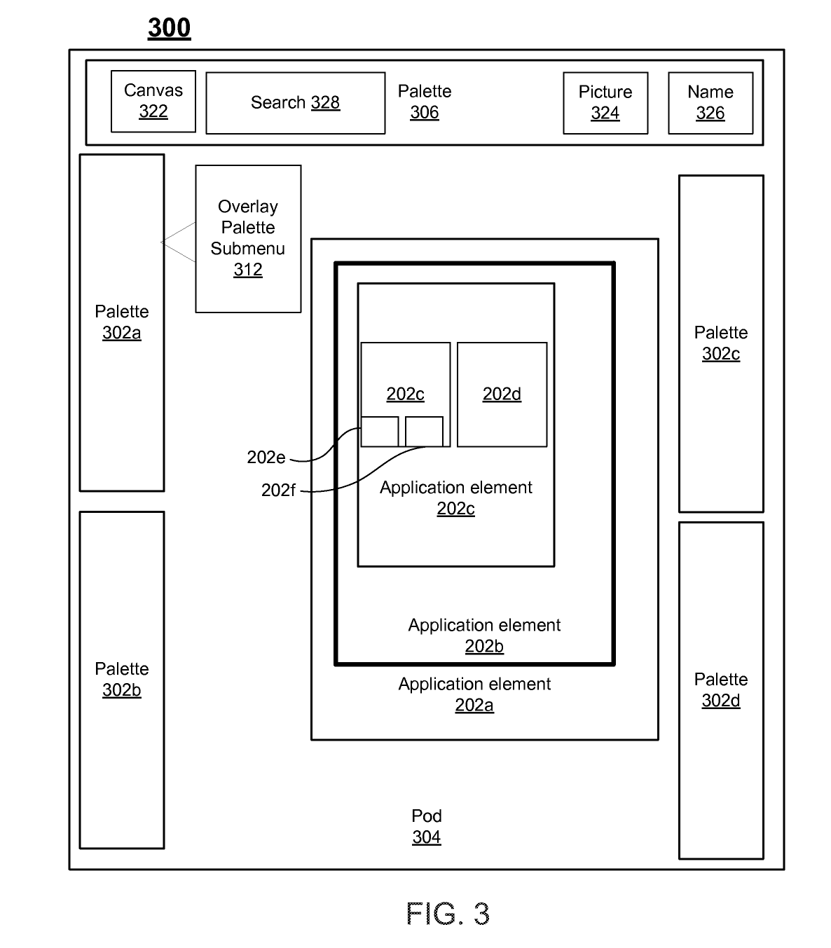

Canvas 200 is a pragmatically boundless application space displayed on user interface 105 that allows a user to pan and zoom between the various interactive application elements 202 and data elements. In some embodiments, each level of application element 202 provides a zoom capability (e.g., powers of ten between zoom stops in an illustrative embodiment). Each level provides deeper context. Navigation on canvas 200 may be continuous. A stop in the zooming of canvas 200 may represent a level of context of canvas 200. The user can navigate around canvas 200 by using standard multi-touch gestures. Pod icon 204 may be displayed on any or all application elements 202 on any or all levels. In some embodiments, canvas model system 112 determines the location of pod icon 204 in canvas 200 or application element 202. In other embodiments, the user may determine the location of the pod icon using pod 304. The user can enter pod 304 (see FIG. 3) by tapping on pod icon 204.

Metadata database 122 stores the metadata associated with each level, each region, and each element on canvas 200. For example, the metadata can help the user quickly navigate to various areas on canvas 200, or cause different application functionality or data to be exposed in pod 304, depending on where the user is on the application space. The context meta-data can also be used by applications at any given level of context, and help identify patterns in the data or application elements 202 that exist at any level of context. The metadata can also be used for a variety of search use cases. Operations at one level of context can effect the display at other levels of application elements 202.

Although canvas 200, application elements 202 and pod icon 204 are shown having a rectangular shape, other shapes, such as circles, ovals, or rectangles with rounded corners may be used. Canvas 200, application elements 202 and pod icon 204 may include or not include borders.

For the sake of clarity and simplicity, the operations of system 100 are described for a single use. However, more than one user may use system 100 either separately or at the same time. System 100 displays a pod icon 204 for each user, and the user may access a pod corresponding to the level of context that the use is in and based on user specific data.

FIG. 3 is a schematic representation of a screenshot 300 of a pod 304. Pod 304 is a control item for navigating, modifying, and manipulating canvas 200 and application elements 202. Pod 304 comprises a plurality of palettes 302a, 302b, 302c, and 302d, a palette 306, and application elements 202a through 202f. Although any number of application elements 202 may be used, for simplicity and clarity, FIG. 3 shows seven application elements 202 (e.g., application element 202a-application element 202f). In some embodiments, canvas 200 and pod 304 operates in a design mode or a run mode. In the design mode, in pod 304, the user may use pod 304 to control canvas 200, such as by adding new application elements, and general selection, sizing, and placement of application elements 202 on canvas 200. Any application element 202 may be selected just by touching the element on pod 304. The size can be expanded or reduced, and the selected application element 202 may be dragged by using the expected multi-touch gestures. In the run mode, application elements on canvas 200 are not selected. The user may navigate on canvas 200, such as zooming or panning of active application elements 202.

Palette 302a is an overlay palette with icons (not shown) for packaged dynamic application elements, such as relevant micro-apps, data visualizations, and predefined application snippets. The dynamic application elements may be data driven, and placed directly on canvas 200 or within frames, under user control. The dynamic application elements, may be, for example, an organization chart generated by a human resources system, a mind map generated by data in a customer relationship management system, a simple table of goals from a database, temperature data tied to a piece of factory equipment, a representation of a supplier network, or a social network. The dynamic application elements may include external services, such as a shopping cart, or a reservation booking system. The dynamic application elements may include application widgets than enable the user to create new application elements on the fly. These include, but are not limited to display, visualization, and storage widgets. Palette 302a includes an overlay palette submenu 312 for each of the packaged dynamic application elements. Each palette 302 includes an overlay palette submenu for each element of the palette 302. For simplicity and clarity, only overlay palette submenu 312 is shown for palette 302a.

Palette 302b is an overlay palette with icons (not shown) for atomic application user interface widgets, such as fields, checkboxes, radio buttons, drop down menus, coverflow, media, feeds, and the like. Palette 302c is an overlay palette with icons (not shown) for static elements, such as for images, videos, files, diagrams, shapes and frames. These elements may be used to create a general framework or motif from which the user can structure a user-specified working environment, or provide clarity in any aspect of the application elements. Palette 302d is an overlay palette with icons (not shown) for design elements, such as colors, fonts, brushes, and the like. Palette 306 is an overlay palette with access to profile, settings, login, navigation, and exit to canvas 200. Palette 306 includes a return to canvas icon 322 to return to the currently viewed location of canvas 200. Palette 306 also includes a picture icon 324 to display a picture or avatar of the user and a name icon 326 to allow access to account profile and application settings of the user. Palette 306 also includes a search or instruction icon 328 for searching or other operations within the canvas from pod 304. This enables rapid navigation to anywhere on canvas 200 at any level of context.

Pod 304 functions as a control panel or a cockpit that provides control beyond the pan and zoom capabilities of canvas 200. Pod 304 may transcend levels of context of canvas 200 and is accessible by tapping on pod icon 204. Pod 304 may be entered using pod icon 204 and exited using canvas icon 322. The user uses pod 304 of a current level of context to navigate, either directly or indirectly, to other levels of context. Pod 304 may use metadata for the current level of context, other levels of context, or canvas 200 for operation or responding to user requests. Pod 304 may be used to define or describe any level of context of canvas 200.

In some embodiments, the default is to leave pod 304 and enter the current level of context in which the corresponding pod icon 204 is positioned. Search icon 328 may be used to find any region or element on canvas 200 and navigate there. Pod 304 allows the user to navigate to any location on the canvas after entering pod 304 from any other location.

In a design mode, pod 304 allows the user to modify canvas 200. Any application element 202 may be selected just by touching user interface 105. The size can be expanded or reduced, and the items can be dragged by using the conventional multi-touch gestures. As an illustrative example, application element 202b is selected to be changed, such as manipulated, enlarged, reduced, and moved. The selected application element 202 may be highlighted or otherwise indicated in user interface 105 that the item has been selected. The user may use pod 304 to define the visual motif of the layers of context of canvas 200.

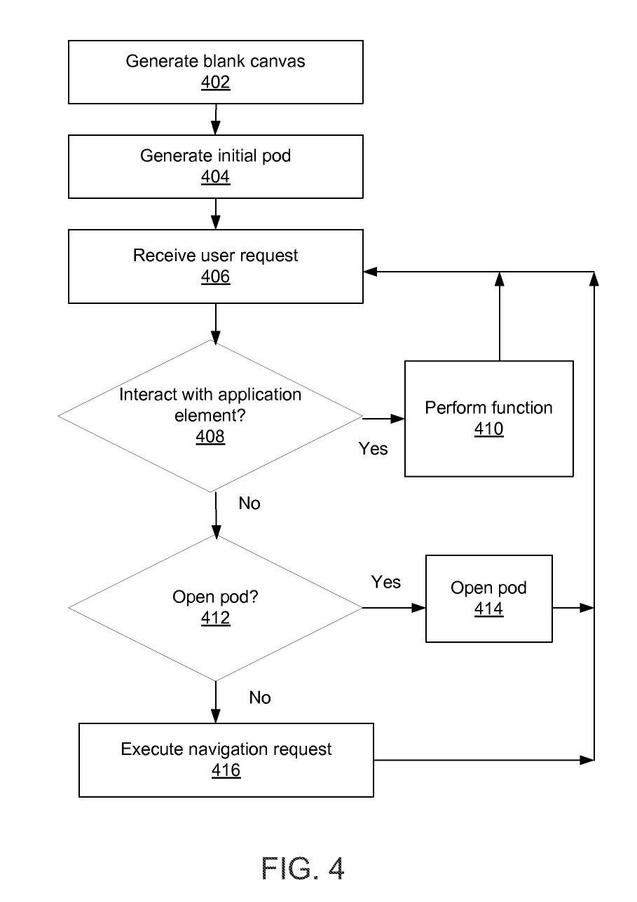

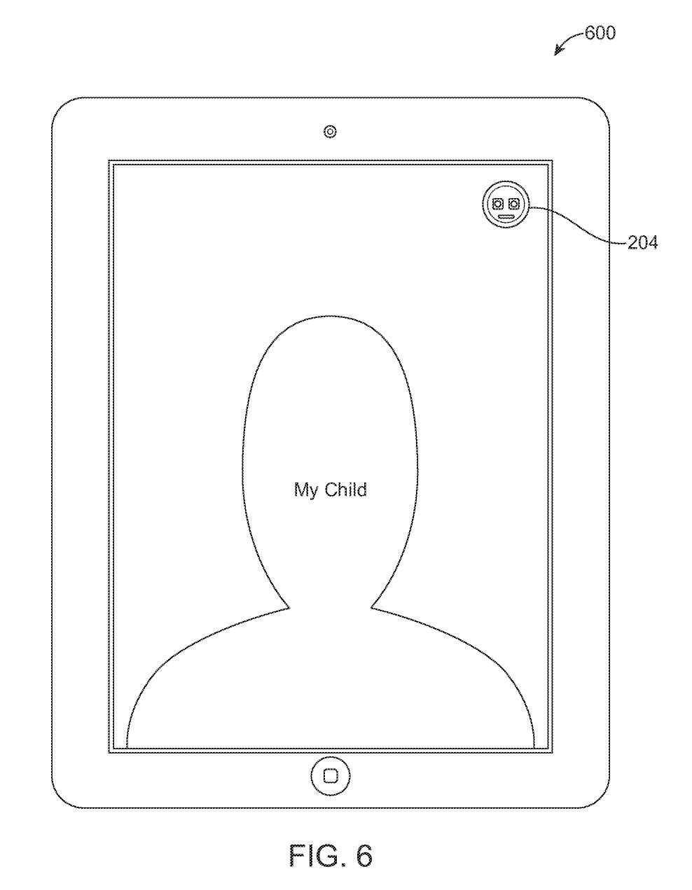

FIG. 4 illustrates a process for generating a user interface with practically boundless canvas and zoom capabilities according to an embodiment of the present invention. The process illustrated in FIG. 4 will be described using the example screenshots illustrated in FIGS. 6-17, which are example screen shots for canvas 200. At 402, canvas modeling engine 125 generates canvas 200 that may be, for example, a blank canvas, an initial canvas, a canvas motif, or a canvas template. FIG. 6 illustrates an example screenshot 600 of canvas 200 that is an initial canvas.

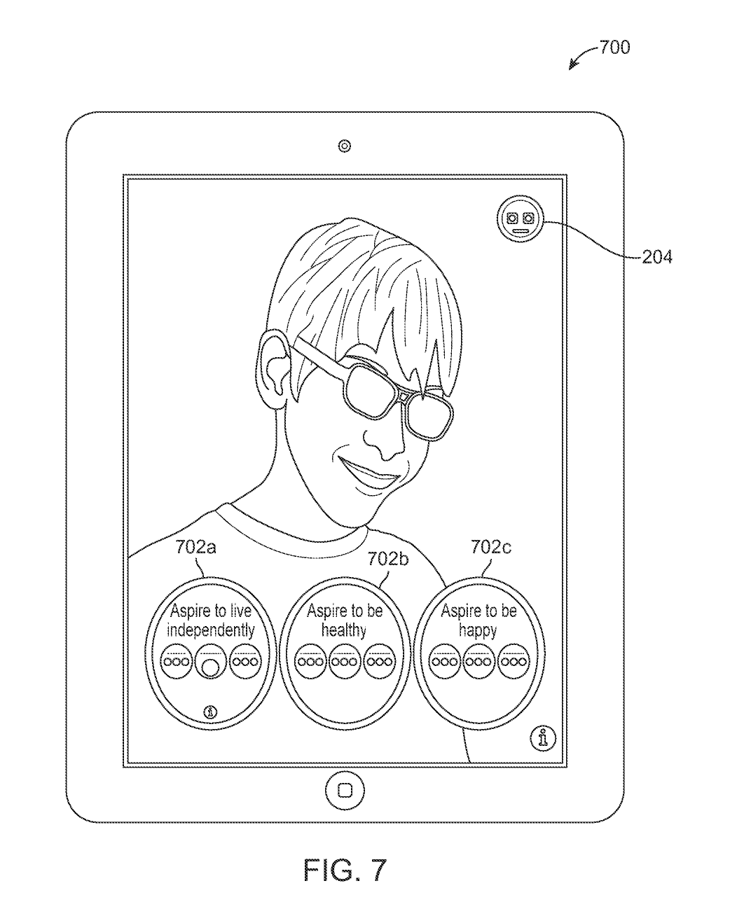

At 404, canvas modeling engine 125 generates an initial pod 304. At 406, canvas modeling engine 125 receives a user request from user interface 105. In some embodiments, the user requests are a request to interact with an application element, a request to open pod 304 and a navigation request (such as pan or zoom). If, at 408, the user request is to interact with an application element, canvas modeling engine 125, at 410, performs the functions corresponding to the requested interaction. The functions may be, for example, entry of data or changing canvas 200. Canvas 200 may be changed from canvas 200 or pod 304. At 406, canvas modeling engine 125 waits for the next user request. FIG. 7 illustrates an example screenshot 700 of canvas 200 having user chosen, modified, or inserted application elements. For example, the parent modifies canvas 200 for the child by inserting a picture of the child and adds three application elements 202 that include aspirations for the child in canvas 200. Canvas 200 has been revised to include a picture of a child of the user, and application elements 702a, 702b, and 702c as illustrative examples of application elements 202. Application element 702a is entitled “aspire to live independently.” Application element 702b is entitled “aspire to be healthy.” Application element 702c is entitled “aspire to be happy.”

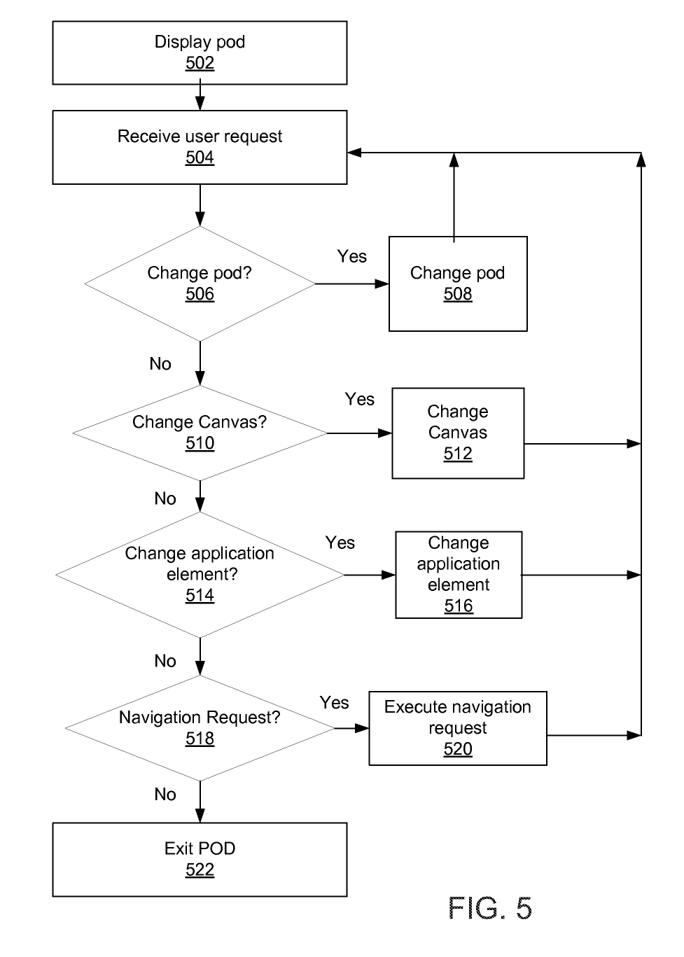

Otherwise, at 412, if the user request is not an instruction to change canvas 200, canvas modeling engine 125 determines whether the instruction is to open pod 304. If, at 412, the instruction is to open pod 304, canvas modeling engine 125 opens pod 304 at 414, and proceeds to the process described below in conjunction with FIG. 5. After returning from the process of FIG. 5, at 406, canvas modeling engine 125 waits for the next user request.

Otherwise, at 412, the user request is a navigation request, canvas modeling engine 125 executes, at 416, the navigation request as described below in conjunction with FIG. 5. After executing the navigation request, canvas modeling engine 125 waits, at 406, for the next user request.

FIG. 5 illustrates a process for navigating and modifying canvas 200, pod 304, and application elements 202 according to an embodiment of the present invention. The process of FIG. 5 may begin from the user request to open pod 304, at 414 of FIG. 4, or execute navigation request at 416 of FIG. 4. At 502, canvas modeling engine 125 opens and displays pod 304, and, at 504, receives a user request from user interface 105. In some embodiments, the user requests to pod 304 are change pod 304, change canvas 200, select application element 202, and a navigation request (such as pan or zoom). If at 506, the user request is to change pod 304, canvas modeling engine 125 changes, at 508, pod 304, such as described above in conjunction with FIG. 3, in response to the user request. The changing of pod 304 may be, for example, opening up a palette, adding new palettes, or in some cases changing applications elements 200. At 504, canvas modeling engine 125 waits for the next user request.

Otherwise, if at 506, the instruction is not an instruction to change pod 304, canvas modeling engine 125 determines, at 510, whether the instruction is an instruction to change canvas 200. If, at 510, the instruction is change canvas 200, canvas modeling engine 125 changes, at 512, canvas 200 in response to the user request. Changing canvas 200 may include, for example, inserting, deleting, moving or changing application elements 200, changing meta data or changing features (e.g., color) of canvas 200, or entering data on canvas 200. At 504, canvas modeling engine 125 waits for the next user request.

Otherwise, if at 510, the instruction is not a request to change canvas 200, canvas modeling engine 125 determines, at 514, whether the instruction is an instruction to change application element 202. If, at 514, the instruction is a change application element 202, canvas modeling engine 125, at 516, changes application element 202. The user may enter data or change application element 202. Changing application element 202 may include, for example, changing metadata, or changing the appearance, size, location, or features of application element 202. Some specific features, size and location may also be changed by changing canvas 304 at 512 described above. At 504, canvas modeling engine 125 waits for the next user request.

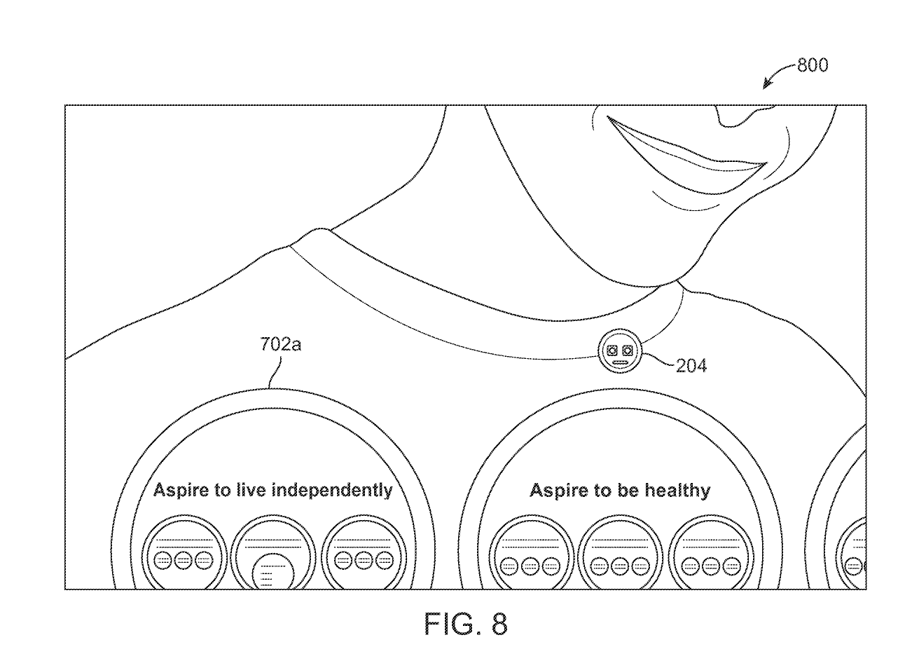

Otherwise, if at 514, the instruction is not an instruction to open application element 202, canvas modeling engine 125 determines, at 518, whether the instruction is a navigation request. If, at 518, the instruction is a navigation request, canvas modeling engine 125 executes, at 520, the navigation request, and returns, at 504, to receiving a user request at 504. The navigation request may be, for example, a zoom instruction or a pan instruction. The user may navigate canvas 200 while in pod 300, or may navigate canvas 200 while not in pod 300. FIGS. 8-17 illustrative example screenshots of canvas 200 at various levels of context of canvas 200 and are described below.

Otherwise, if at 518, the instruction is not a navigation request, at 522, the instruction is an instruction to exit pod 304 from return to canvas icon 322 (see FIG. 3), and canvas modeling engine 125 displays canvas 200 at the currently viewed location of canvas 200 and waits for the next user request at 406 (see FIG. 4).

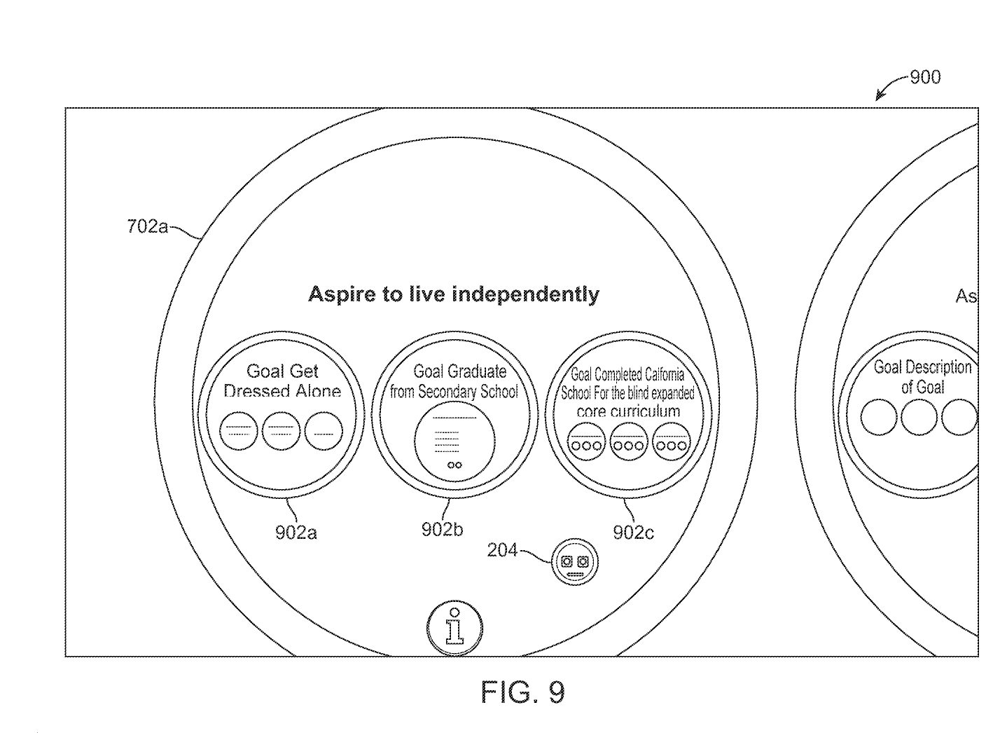

FIG. 8 illustrates an example screenshot 800 of canvas 200 at a first level of context in which the user is zooming in on application element 702a. Further, zoom instructions provide additional zooming of levels of context or of application elements 202. FIG. 9 illustrates an example screenshot 900 of canvas 200 at a second level of context in which the user is zooming in on application element 702a that includes application elements 902a, 902b, and 902c as illustrative examples of application elements 202. Application element 902a is entitled “Goal: get dressed alone.” Application element 902b is entitled “Goal: graduate from secondary school.” Application element 902c is entitled “Goal: completed California School for the blind expanded core curriculum.”

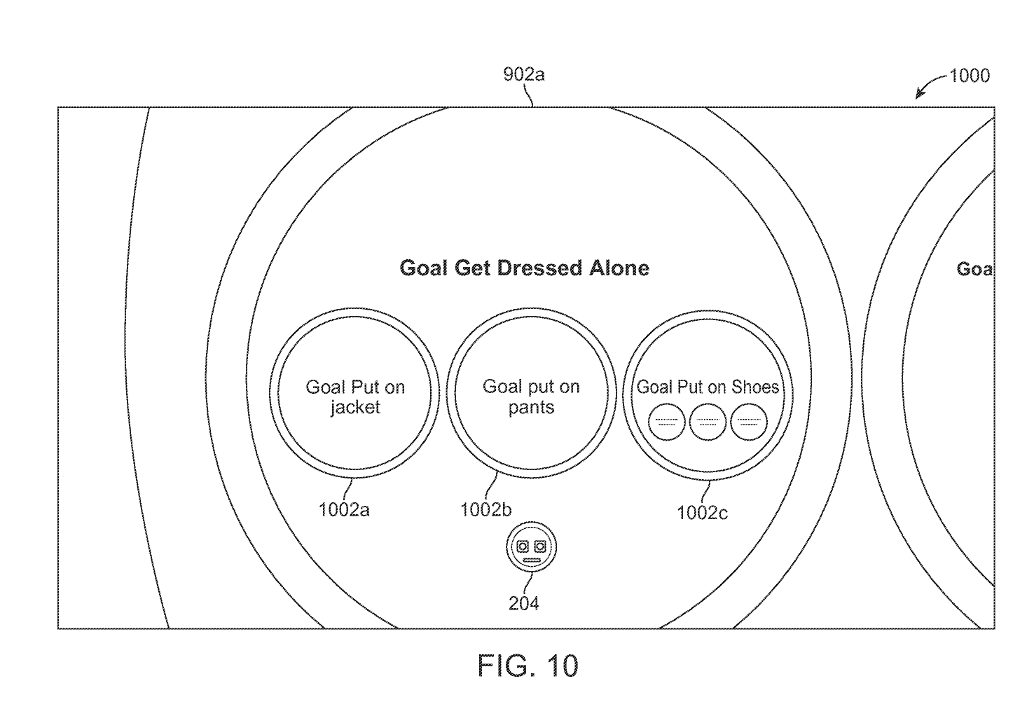

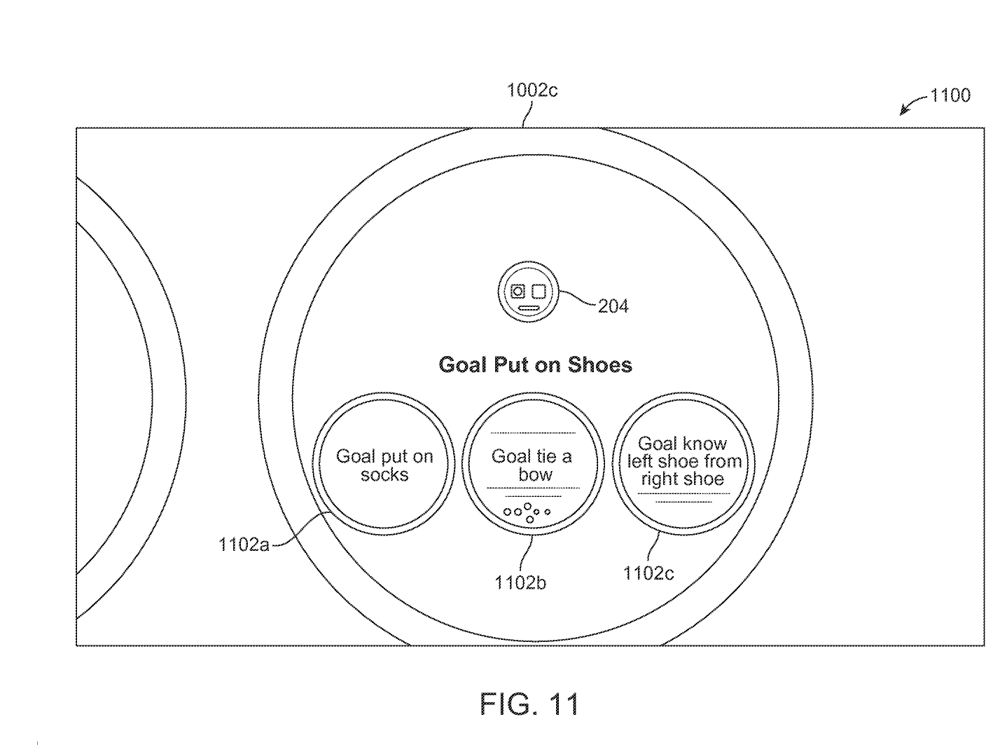

FIG. 10 illustrates an example screenshot 1000 of canvas 200 at a third level of context in which the user is zooming in on application element 902a that includes application elements 1002a, 1002b, and 1002c as illustrative examples of application elements 202. Application element 1002a is entitled “Goal: put on jacket.” Application element 1002b is entitled “Goal: put on pants.” Application element 1002c is entitled “Goal: put on shoes.” Application elements 1002 include goals at a lower level for achieving the corresponding aspiration. The user may zoom further on one of the application elements 1002. FIG. 11 illustrates an example screenshot 1100 of canvas 200 at a fourth level of context in which the user is zooming in on application element 1002c that includes application elements 1102a, 1102b, and 1102c as illustrative examples of application elements 202. Application element 1102a is entitled “Goal: put on socks.” Application element 1102b is entitled “Goal: tie a bow.” Application element 1102c is entitled “Goal: know left shoe from right shoe.”

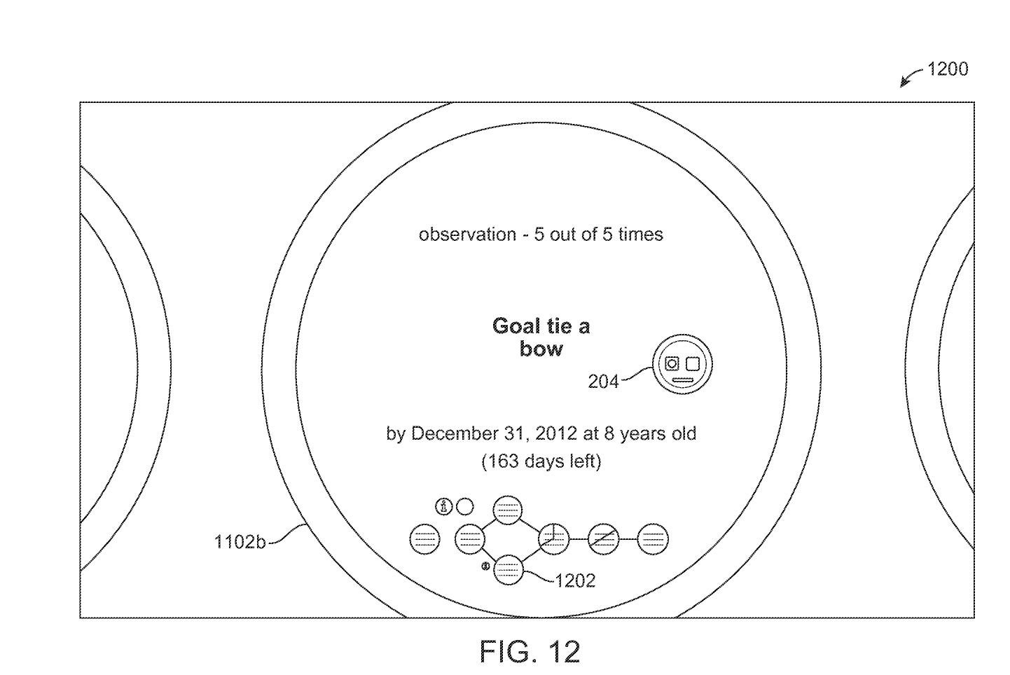

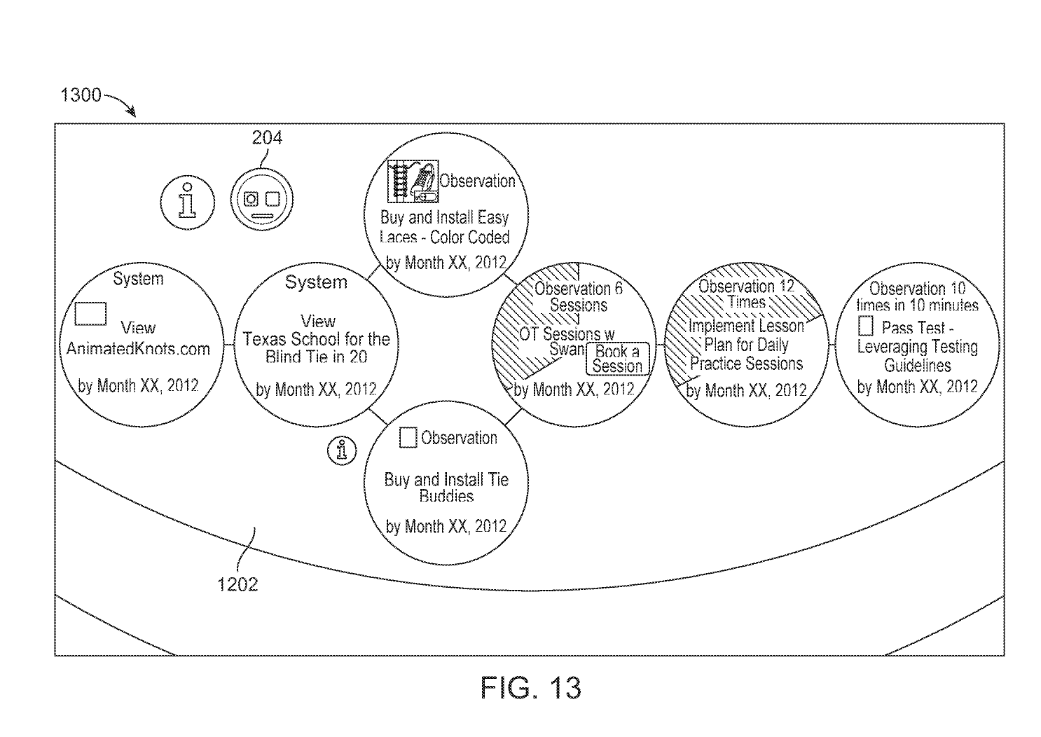

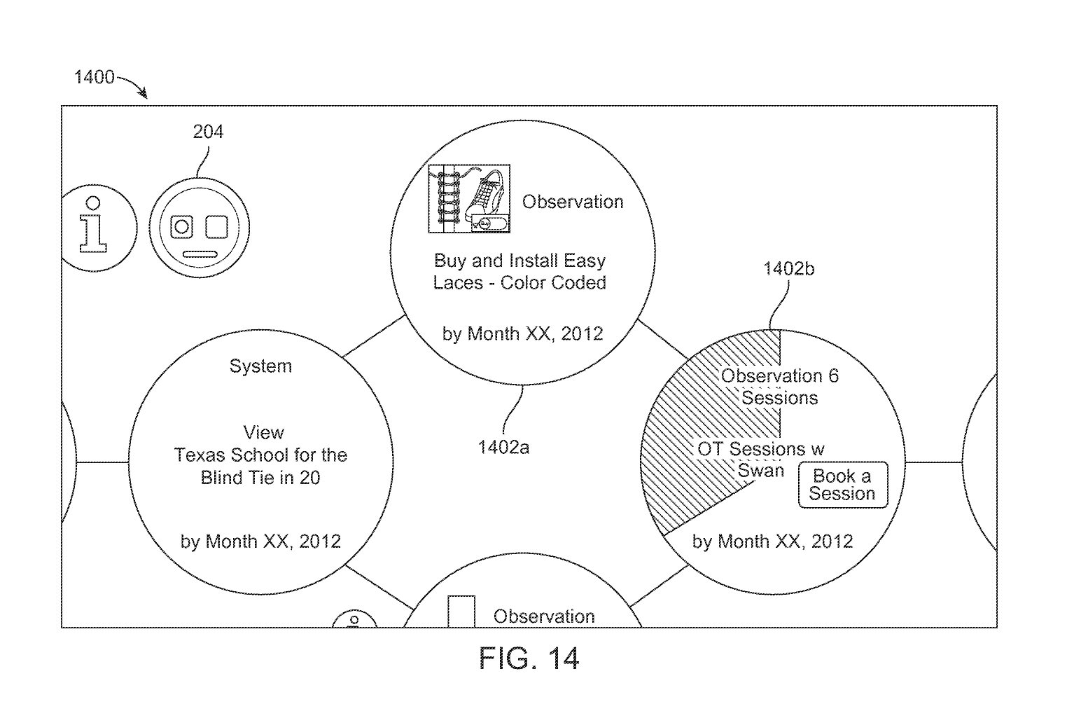

The user may zoom further on one of the application elements 1102. FIG. 12 illustrates an example screenshot 1200 of canvas 200 at a fifth level of context in which the user is zooming in on application element 1102b that includes application elements 1202 as illustrative examples of application elements 202. Application elements 1402 include resources at a lower level for achieving the corresponding goal. Application elements 1202 are shown as being interconnected or linked. The interconnections or links may be the same level of context or to a deeper level of context. Although not shown in FIG. 12, application elements 1202 may be nested in other application elements 1202, or application elements of other levels of context (such as application elements 702, 902, 1002, 1102 or 1402 (see FIG. 14)). Application element 1202 shows user provided progress towards a goal (in this example with the corresponding circular areas being either partially or fully shaded, depending on progress). The application elements of FIGS. 6-12 may also have interconnections or links between the application elements as desired. FIGS. 13 and 14 illustrate example screenshots 1300 and 1400, respectively, of canvas 200 at sixth and seventh levels, respectively, of context in which the user is zooming in on application element 1202. For simplicity and clarity, only two application elements 1402a and 1402b are labeled. Application elements 1402 include resources at a lower level for achieving the corresponding goal.

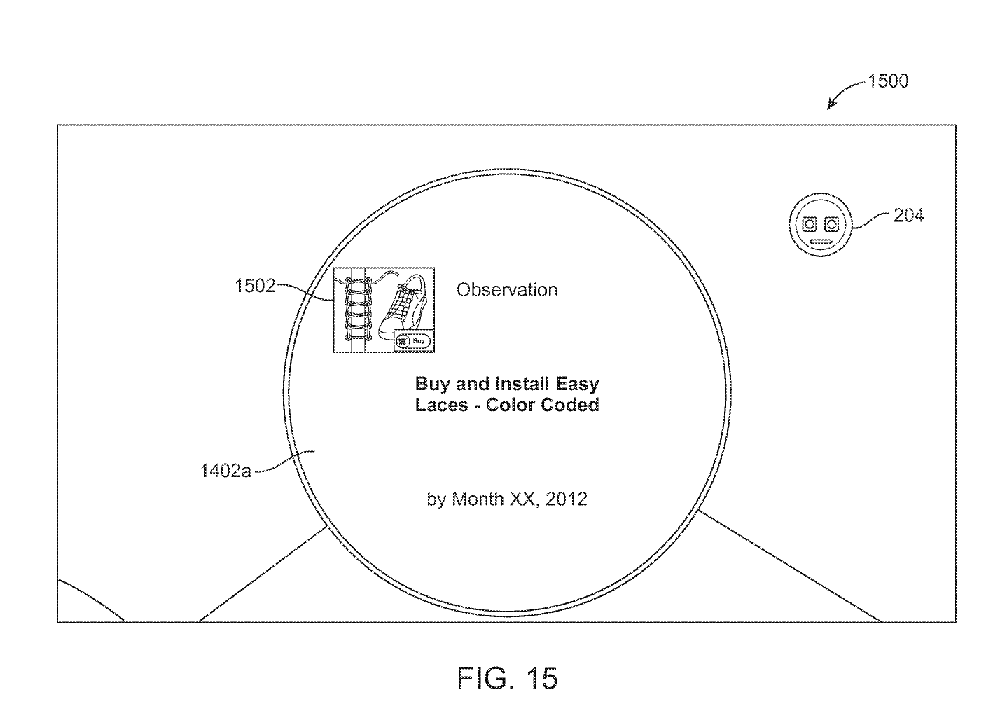

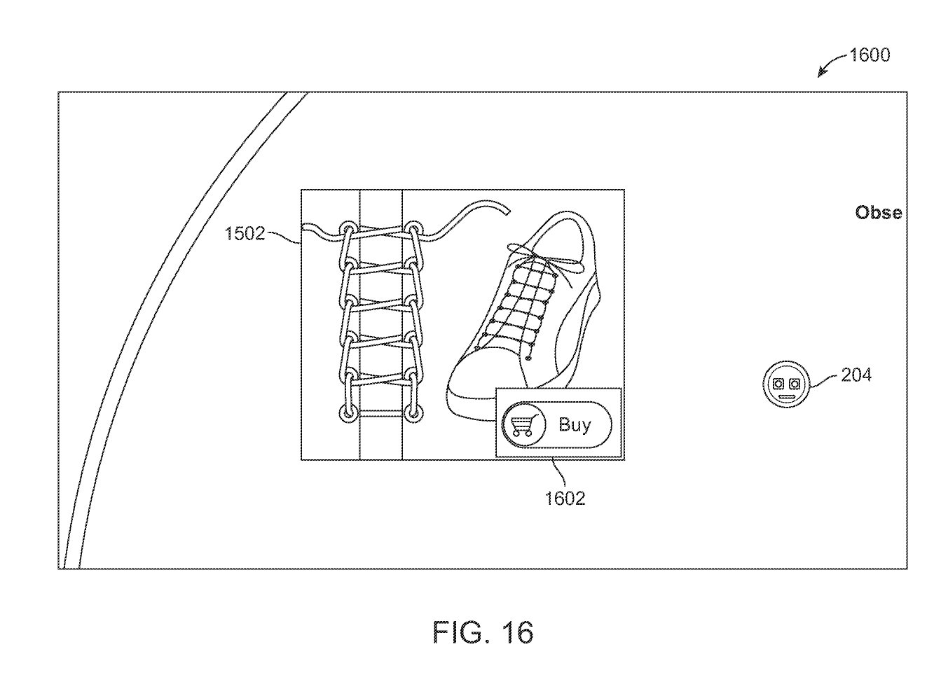

The user may zoom further on one of the application elements 1402. FIG. 15 illustrates an example screenshot 1500 of canvas 200 at an eighth level of context in which the user is zooming in on application element 1402a that include an application element 1502. FIG. 16 illustrates an example screenshot 1600 of canvas 200 at a ninth level of context in which the user is zooming in on application element 1502. Application element 1502 includes an application element 1602 that, in an illustrative example, is a shopping cart icon that allows the user to purchase a resource, specifically shoe laces. The user may include the shopping cart icon as part of the revised canvas 200 at 410 of FIG. 4.

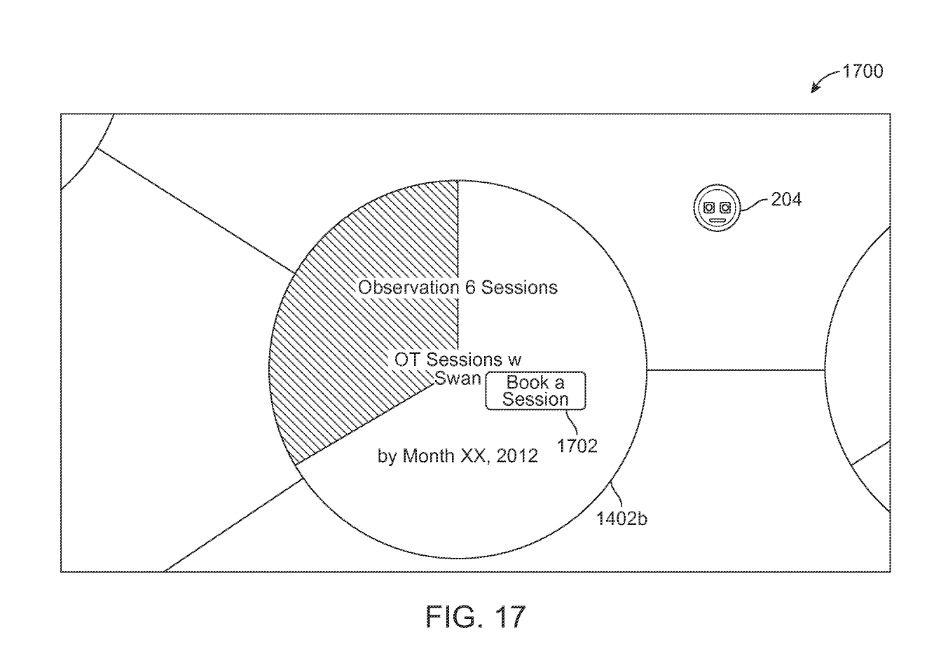

Referring again to FIG. 14, the user may zoom further on another application element, such as application element 1402b. FIG. 17 illustrates an example screenshot 1700 of canvas 200 at an alternative eighth level of context in which the user is zooming in on application element 1402b that includes an application element 1702. In an illustrative example, application element 1702 is a link to a reservation management system. The user may include the application element 1702 as part of the revised canvas 200 at 410 of FIG. 4.

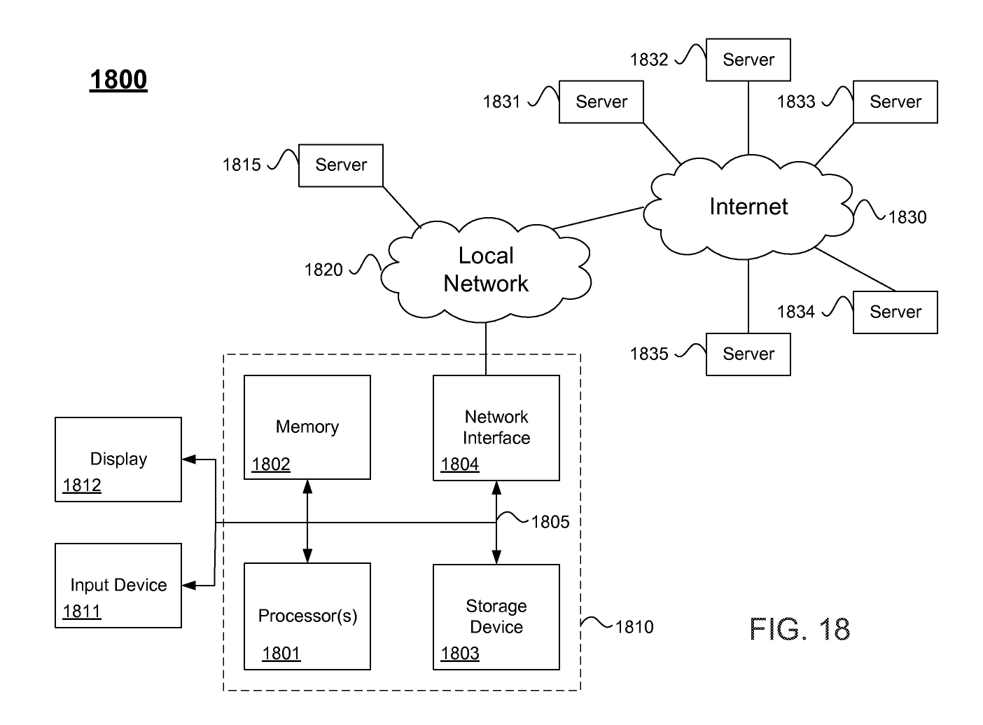

FIG. 18 illustrates hardware used to implement embodiments of the present invention. An example computer system 1810 is illustrated in FIG. 18. Computer system 1810 includes a bus 1805 or other communication mechanism for communicating information, and one or more processors 1801 coupled with bus 1805 for processing information. Computer system 1810 also includes a memory 1802 coupled to bus 1805 for storing information and instructions to be executed by processor 1801, including information and instructions for performing the techniques described above, for example. This memory may also be used for storing variables or other intermediate information during execution of instructions to be executed by processor 1801. Possible implementations of this memory may be, but are not limited to, random access memory (RAM), read only memory (ROM), or both. A machine readable storage device 1803 is also provided for storing information and instructions. Common forms of storage devices include, for example, a non-transitory electromagnetic medium such as a hard drive, a magnetic disk, an optical disk, a CD-ROM, a DVD, Blu-Ray, a flash memory, a USB memory card, or any other medium from which a computer can read. Storage device 1803 may include source code, binary code, or software files for performing the techniques above, for example. Storage device 1803 and memory 1802 are both examples of computer readable mediums.

Computer system 1810 may be coupled via bus 1805 to a display 1812, such as a cathode ray tube (CRT), plasma display, light emitting diode (LED) display, or liquid crystal display (LCD), for displaying information to a computer user. An input device 1811 such as a keyboard, mouse and/or touch screen is coupled to bus 1805 for communicating information and command selections from the user to processor 1801. The combination of these components allows the user to communicate with the system, and may include, for example, user interface 105. In some systems, bus 1805 may be divided into multiple specialized buses.

Computer system 1810 also includes a network interface 1804 coupled with bus 1805. Network interface 1804 may provide two-way data communication between computer system 1810 and the local network 1820, for example. The network interface 1804 may be a wireless network interface, a cable modem, a digital subscriber line (DSL) or a modem to provide data communication connection over a telephone line, for example. Another example of the network interface is a local area network (LAN) card to provide a data communication connection to a compatible LAN. Wireless links are another example. In any such implementation, network interface 1804 sends and receives electrical, electromagnetic, or optical signals that carry digital data streams representing various types of information.

Computer system 1810 can send and receive information, including messages or other interface actions, through the network interface 1804 across a local network 1820, an Intranet, or the Internet 1830. For a local network, computer system 1810 may communicate with a plurality of other computer machines, such as server 1815. Accordingly, computer system 1810 and server computer systems represented by server 1815 may be programmed with processes described herein. In the Internet example, software components or services may reside on multiple different computer systems 1810 or servers 1831-1835 across the network. Some or all of the processes described above may be implemented on one or more servers, for example. Specifically, data store 108 and canvas model system 112 or elements thereof might be located on different computer systems 1810 or one or more servers 1815 and 1831-1835, for example. A server 1831 may transmit actions or messages from one component, through Internet 1830, local network 1820, and network interface 1804 to a component on computer system 1810. The software components and processes described above may be implemented on any computer system and send and/or receive information across a network, for example.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A computer-implemented method comprising:
receiving a user request in a controller, wherein the controller stores information about the display of data on a canvas,
wherein a data store stores the data and the canvas;
generating, by the controller, the canvas for display on a user interface, the canvas including a plurality of application elements and a pod, the canvas being displayable in levels of context;
generating first display information based on the canvas and a first type of user request, the first display information including one of the levels of context of the canvas and the pod;
generating second display information of the pod based on the pod and a second type of user request, the second display information including application elements of a selected level of context of the canvas; and
modifying a selected application element of the second display information based on a third type of user request.

2. The method of claim 1, wherein modifying the selected application element further comprises:
inserting a dynamic application element in the selected level of context of the canvas.

3. The method of claim 1, wherein modifying the selected application element further comprises:
inserting a selected one of a static application element and a dynamic application element in the selected level of context of the canvas in the second display information.

4. The method of claim 1 further comprising:
generating third display information based on the canvas and a third type of user request, after modifying the selected application element of the second display information.

5. The method of claim 1 wherein the second type of user request includes a plurality of palettes, each palette including a plurality of icons, each icon corresponding to a function to be performed by the controller for navigating or modifying the canvas, application elements and levels of context.

6. The method of claim 1 further comprising:
regenerating the first display information based a fourth type of user request, after generating the second display information.

7. The method of claim 6 wherein the second display information includes a canvas icon, the fourth type of user request is an instruction to navigate back to the canvas received in response to a selection of the canvas icon.

8. The method of claim 1 wherein the first type of user request is an instruction to navigate between levels of context of the canvas.

9. The method of claim 1 wherein the first display information includes the pod in every level of context of the canvas.

10. The method of claim 1 wherein the first display information includes the pod in every application element in the selected level of context of the canvas.

11. The method of claim 9 wherein the pod in the first display information has identical forms in every level of context of the canvas.

12. The method of claim 1 further comprising:
searching the canvas based on a fifth type of user request;
determining a location in the canvas based on the search of the canvas; and
generating fourth display information based on the determined location in the canvas in response to a user request to navigate to the determined location.

13. The method of claim 1 further comprising:
interconnecting application elements in the canvas based on a sixth type of user request.

14. The method of claim 1 wherein modifying the selected application element further comprises:
inserting, deleting or modifying a selected one of a static application element and a dynamic application element in the selected level of context of the canvas in the second display information.

15. A computer readable medium embodying a computer program for performing a method, said method comprising:
receiving a user request in a controller, wherein the controller stores information about the display of data on a canvas,
wherein a data store stores the data and the canvas;
generating, by the controller, the canvas for display on a user interface, the canvas including a plurality of application elements and a pod, the canvas being displayable in levels of context;
generating first display information based on the canvas and a first type of user request, the first display information including one of the levels of context of the canvas and the pod;
generating second display information of the pod based on the pod and a second type of user request, the second display information including application elements of a selected level of context of the canvas; and
modifying a selected application element of the second display information based on a third type of user request.

16. The computer readable medium of claim 15 wherein modifying the selected application element further comprises inserting a dynamic application element in the selected level of context of the canvas.

17. The computer readable medium of claim 15 wherein the first display information includes the pod in every level of context of the canvas.

18. A computer system comprising:
one or more processors;
a controller, the controller receiving a user request, wherein the controller stores information about the display of data on a canvas
wherein a data store stores the data and the canvas;
the controller generating the canvas for display on a user interface, the canvas including a plurality of application elements and a pod, the canvas being displayable in levels of context, generating first display information based on the canvas and a first type of user request, the first display information including one of the levels of context of the canvas and the pod, generating second display information of the pod based on the pod and a second type of user request, the second display information including application elements of a selected level of context of the canvas, and modifying a selected application element of the second display information based on a third type of user request.

19. The computer system of claim 18 wherein the controller modifies the selected application element by inserting a dynamic application element in the selected level of context of the canvas.

20. The computer system of claim 18 wherein the first display information includes the pod in every level of context of the canvas.
